(19) United States
(12) Patent Application Publication
(10) Pub. No.: US 2026/0017011 A1
(43) Pub. Date: Jan. 15, 2026

(54) AUDIO PROCESSING METHOD AND APPARATUS BASED ON MULTI-MACHINE INTERACTION AND STORAGE MEDIUM

(71) Applicant: KANDAO TECHNOLOGY CO., LTD., Shenzhen (CN)

(72) Inventors: Zhiyou MA, Shenzhen (CN); Youlong LIU, Shenzhen (CN)

(73) Assignee: KANDAO TECHNOLOGY CO., LTD., Shenzhen (CN)

(21) Appl. No.: 19/332,559

(22) Filed: Sep. 18, 2025

Related U.S. Application Data
(63) Continuation of application No. PCT/CN2024/082631, filed on Mar. 20, 2024.

(30) Foreign Application Priority Data
Jul. 19, 2023 (CN) 202310894131.8

(51) Int. Cl. G06F 3/16

(52) U.S. Cl. CPC G06F 3/165; G06F 3/162

(57) ABSTRACT

An audio processing method based on multi-machine interaction comprises: in response to an audio transmission instruction triggered by local software, acquiring first audio data corresponding to the audio transmission instruction; synchronizing the first audio data with target software by a first virtual interface of a virtual loudspeaker, so that the local software outputs the audio data; receiving second audio data sent by the target software; and sending the second audio data to a virtual microphone by a second virtual interface of the virtual microphone, and sending the second audio data in the virtual microphone to the local software, so that the local software inputs the audio data.

### CROSS-REFERENCE TO RELATED APPLICATIONS

This application is a continuation of International Patent Application No. PCT/CN2024/082631 with a filing date of Mar. 20, 2024, designating the United States, now pending, and further claims priority to Chinese Patent Application No. 202310894131.8 with a filing date of Jul. 19, 2023. The content of the aforementioned applications, including any intervening amendments thereto, is incorporated herein by reference.

### TECHNICAL FIELD

The present disclosure relates to the field of video technology, and particularly to an audio processing method and apparatus based on multi-machine interaction, and a storage medium.

### BACKGROUND OF THE INVENTION

Currently, paired virtual sound cards are employed to realize speaker playback and microphone recording. In a paired virtual sound card setup, the virtual loudspeaker and the virtual microphone must be used in pairs. That is, one virtual sound card simulates one type of application (such as a virtual loudspeaker or a virtual microphone). To utilize both the speaker and microphone functions of paired virtual sound cards, two paired virtual sound cards are required. The specific workflow is illustrated in FIG. 1. Application A forwards audio data to Application B as microphone recording input via the virtual loudspeaker of the first virtual sound card and the virtual microphone of the first virtual sound card. Meanwhile, Application B forwards sound to a virtual microphone via the virtual loudspeaker of the second virtual sound card, enabling Application A to collect the sound from the virtual microphone of the second virtual sound card through microphone recording.

However, in the scenario of multi-machine interaction for multi-person online conferences, there are often multiple users participating in the online conference from different locations. This means that multiple applications need to utilize virtual sound cards for speaker playback and microphone recording. If paired virtual sound cards are employed to achieve speaker playback and microphone recording, multiple paired virtual sound cards will be required. Moreover, since each paired virtual sound card corresponds to one application and they have different names, when users need to adjust the sound settings of a specific virtual sound card, errors in adjustment are prone to occur.

### SUMMARY OF THE INVENTION

The present disclosure provides an audio processing method and apparatus based on multi-machine interaction, and a storage medium, in a scenario of multi-machine interaction, there is no need to configure a plurality of virtual sound cards, thereby avoiding adjustment errors caused by different names of virtual sound cards.

In a first aspect, the present disclosure provides an audio processing method based on multi-machine interaction, including:
in response to an audio transmission instruction triggered by local software, acquiring first audio data corresponding to the audio transmission instruction;
synchronizing the first audio data with target software by a first virtual interface of a virtual loudspeaker, so that the local software outputs the audio data, the virtual loudspeaker being a preset virtual output device of the local software; wherein the virtual loudspeaker is configured to control output audio data;
receiving second audio data sent by the target software, the second audio data being an integration result of user audio data collected by the target software; and
sending the second audio data to a virtual microphone by a second virtual interface of the virtual microphone, and sending the second audio data in the virtual microphone to the local software, so that the local software inputs the audio data, the virtual microphone being a preset virtual input device of the local software; wherein the virtual microphone is configured to control input audio data.

In a second aspect, the disclosure also provides an audio processing apparatus based on multi-machine interaction, including:
an acquisition module, configured to, in response to an audio transmission instruction triggered by local software, acquire first audio data corresponding to the audio transmission instruction;
a synchronization module, configured to synchronize the first audio data with target software by a first virtual interface of a virtual loudspeaker, so that the local software outputs the audio data, the virtual loudspeaker being a preset virtual output device of the local software; wherein the virtual loudspeaker is configured to control output audio data;
a receiving module, configured to receive second audio data sent by the target software, the second audio data being an integration result of user audio data collected by the target software; and
a sending module, configured to send the second audio data to a virtual microphone by a second virtual interface of the virtual microphone, and sending the second audio data in the virtual microphone to the local software, so that the local software inputs the audio data, the virtual microphone being a preset virtual input device of the local software; wherein the virtual microphone is configured to control input audio data.

In a third aspect, the present disclosure also proposes a computer storage medium having stored therein a computer program which, when executed, implements the audio processing method based on multi-machine interaction according to any one of the aforementioned content.

Provided in the present disclosure are an audio processing method and apparatus based on multi-machine interaction, and a storage medium. The method includes: in response to an audio transmission instruction triggered by local software, acquiring first audio data corresponding to the audio transmission instruction; synchronizing the first audio data with target software by a first virtual interface of a virtual loudspeaker, so that the local software outputs the audio data, the virtual loudspeaker being a preset virtual output device of the local software; wherein the virtual loudspeaker is configured to control output audio data; receiving second audio data sent by the target software, the second audio data being an integration result of user audio data collected by the target software; and sending the second audio data to a virtual microphone by a second virtual interface of the virtual microphone, and sending the second audio data in the virtual microphone to the local software, so that the local software inputs the audio data, the virtual microphone being a preset virtual input device of the local software; wherein the virtual microphone is configured to control input audio data. In the audio processing solution provided by this disclosure, the local software can output the first audio data to the target software through the first virtual interface of a virtual loudspeaker. Meanwhile, the target software can input the second audio data into the local software through the second virtual interface of a virtual microphone. In other words, audio data input and output for the target software are achieved through a single virtual sound card. It can be seen that, in a multi-machine interaction scenario, there is no need to configure multiple virtual sound cards, thus avoiding adjustment errors caused by different names of virtual sound cards.

### BRIEF DESCRIPTION OF DRAWINGS

In order to more clearly explain the embodiments of the present disclosure or the technical solutions in the prior art, the drawings that need to be used in the embodiments will be briefly introduced below, and the drawings in the following description are only corresponding drawings of some embodiments of the present disclosure, and for those skilled in the art, drawings of other embodiments can also be obtained according to these drawings without making creative labor.

FIG. 1 is a structural diagram of an existing virtual sound card;

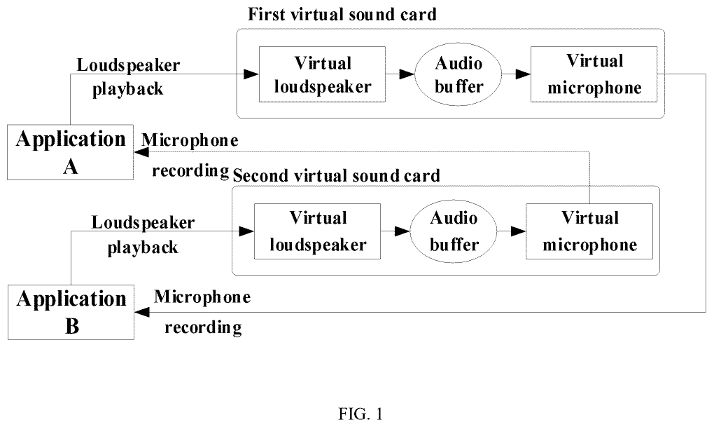

FIG. 2 is a flowchart illustrating an audio processing method based on multi-machine interaction according to an embodiment of the present disclosure;

FIG. 3 is a schematic diagram of data exchange in a unified virtual sound card according to an embodiment of the present disclosure;

FIG. 4 is another schematic diagram of data exchange in a unified virtual sound card according to an embodiment of the present disclosure;

FIG. 5 is a schematic diagram illustrating a specific structure of a virtual loudspeaker in a unified virtual sound card according to an embodiment of the present disclosure;

FIG. 6 is yet another schematic diagram of data exchange in a unified virtual sound card according to an embodiment of the present disclosure;

FIG. 7 is a schematic diagram of the structure of an audio processing apparatus based on multi-machine interaction according to an embodiment of the present disclosure; and

FIG. 8 is another schematic diagram of the structure of an audio processing apparatus based on multi-machine interaction according to an embodiment of the present disclosure.

### DETAILED DESCRIPTION OF THE INVENTION

Hereinafter, the technical solutions in the embodiments of the present disclosure will be clearly and completely described with reference to the accompanying drawings in the embodiments of the present disclosure, and it is obvious that the described embodiments are only some embodiments of the present disclosure, but not all embodiments. Based on the embodiments in the present disclosure, all other embodiments obtained by those skilled in the art without making creative efforts belong to the scope of protection of the present disclosure.

Unless defined otherwise, all technical and scientific terms used herein have the same meaning as commonly understood by those of ordinary skill in the art to which this disclosure belongs.

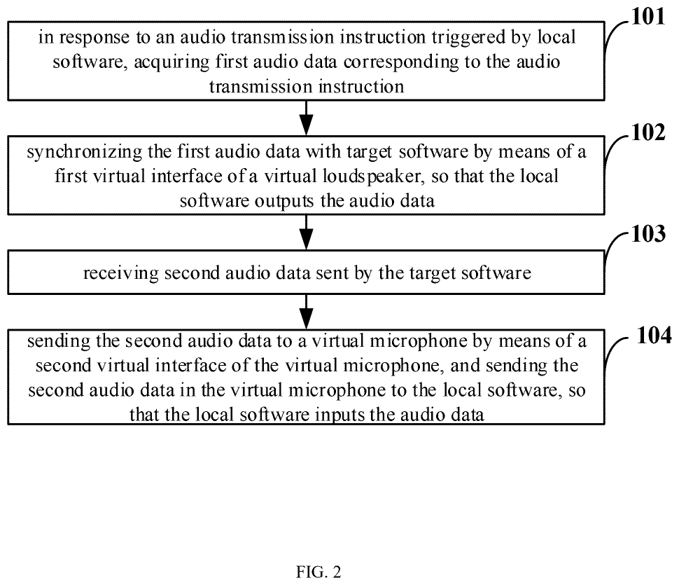

Referring to FIG. 2, the present disclosure is an audio processing method based on multi-machine interaction, including:

101, in response to an audio transmission instruction triggered by local software, first audio data corresponding to the audio transmission instruction is acquired.

In this step, the local software can be multi-person video software or online conferencing software. The audio transmission instruction can be triggered when the local software establishes a communication connection with the target software, or when the microphone of the terminal corresponding to the local software collects the voice of the user. That is, the local software triggers the audio transmission instruction upon detecting that the microphone has collected the voice of the user. This audio transmission instruction carries the audio data to be transmitted (i.e., the first audio data), which can include not only the voice data of the user but also sound data from the surrounding environment, and so on.

102, the first audio data is synchronized with target software by a first virtual interface of a virtual loudspeaker, so that the local software outputs the audio data.

In this disclosure, both the virtual loudspeaker and the virtual microphone are components of a virtual sound card. The virtual sound card is a device that, at the driver level of the operating system and based on the Windows Driver Model, simulates the speaker and microphone functions of a sound card. Since the virtual sound card is equipped with both a virtual loudspeaker and a virtual microphone, its functions are consistent with those of a real sound card along with its speaker and microphone, including capabilities for recording and playback, supporting sound format settings, adjusting volume levels (increase and decrease), and mixing audio signals. It can be understood that local software can perform data input and output through its corresponding virtual sound card.

Optionally, in some embodiments, the audio processing method based on multi-machine interaction of the present disclosure may further include:
(11) a virtual sound card including one virtual loudspeaker and one virtual microphone is preset; and
(12) the virtual sound card is bound with local software so that the local software performs data input and output by the virtual sound card.

For example, specifically, for local software such as software a, software b, and software c, virtual sound cards A, B, and C can be preset respectively. Each of these virtual sound cards includes only one virtual loudspeaker and one virtual microphone. After the setup, the software a is bound with the virtual sound card A, the software b is bound with the virtual sound card B, and the software c is bound with the virtual sound card C. Moreover, after binding, the identification of these virtual sound cards can also be displayed on a sound card display interface. For example, when the virtual sound card A is displayed, it is shown as virtual sound card (a), indicating that this virtual sound card (a) is bound with the software a.

During the actual use of software, adjustments can be made to the input and/or output of the software via a virtual sound card, such as increasing the output volume or decreasing the input volume, and so on. In other words, audio data input and output for the target software can be managed through a single virtual sound card. It can be seen that in multi-computer interaction scenarios, there is no need to configure multiple virtual sound cards, thereby avoiding adjustment errors that may arise due to different names of the virtual sound cards.

Since the virtual sound card operates in the kernel mode of the operating system, that is, the virtual loudspeaker also resides in the kernel mode, while the target software operates in the user mode of the operating system, to facilitate communication between the virtual loudspeaker and the target software. In some embodiments of the present disclosure, a data interface (i.e., the first virtual interface) of the communication between the virtual loudspeaker and the target software is preset for data exchange. Specifically, the virtual loudspeaker serves as a pre-set virtual output device of the local software, and it is configured to control the output audio data, such as adjusting the volume level, and so on.

When the local software transmits the first audio data to the virtual loudspeaker, the virtual loudspeaker does not directly play the audio. Instead, it buffers the first audio data into a buffering area. Subsequently, a preset speaker forwarding service extracts the corresponding first audio data from the buffering area through the first virtual interface and synchronizes the extracted first audio data to the terminal corresponding to the target software. That is, optionally, in some embodiments, the step that “the first audio data is synchronized with the target software by the first virtual interface of the virtual loudspeaker” may specifically include:
(21) the first audio data is buffered into a first preset buffering area by the virtual loudspeaker; and
(22) the first audio data buffered in the first preset buffering area is synchronized with a terminal corresponding to target software by a first virtual interface of the virtual loudspeaker based on a speaker forwarding service.

In above steps, the speaker forwarding service is bound with the first preset buffering area. This service is responsible for extracting data buffered in the first buffering area and synchronizing the extracted first audio data with the terminal corresponding to the target software, so that the terminal can play the audio corresponding to the first audio data through components such as speakers.

Furthermore, the virtual loudspeaker forwards data through the first virtual interface, and the core service (SnapServer) synchronizes the first audio data with the corresponding target software, enabling the terminal corresponding to the target software to play the audio corresponding to the first audio data. That is, optionally, in some embodiments, the step that “the first audio data buffered in the first preset buffering area is synchronized with the terminal corresponding to the target software by the first virtual interface of the virtual loudspeaker based on the speaker forwarding service” may specifically include:
(31) first audio data buffered in the first preset buffering area is forwarded to a core service by a first virtual interface of the virtual loudspeaker in response to an extraction instruction of a speaker forwarding service for the first preset buffering area; and
(32) the first audio data is synchronized with a target terminal corresponding to target software based on the core service and a Network Time Protocol.

Optionally, in some embodiments, the present disclosure employs the Snapcast audio system, which is divided into two parts: a server and clients. The server is responsible for capturing audio data and transmitting the captured audio data to terminals within the audio system. The clients include terminals corresponding to the local software as well as terminals corresponding to the target software. Specifically, after a communication connection is established between the local software and the target software, in response to an extraction instruction from the speaker forwarding service for the first preset buffering area, the first audio data buffered in the first preset buffering area is extracted through the first virtual interface. Subsequently, in response to the forwarding operation of the speaker forwarding service, the first audio data is forwarded to the core service. The core service, SnapServer, then identifies the corresponding terminal, SnapClient, and synchronizes the first audio data to the identified terminal SnapClient (i.e., the target terminal corresponding to the target software) based on the Network Time Protocol.

It should be noted that the Network Time Protocol (NTP) is a protocol used to synchronize computer time. It enables computers to synchronize with their servers or clock sources (such as quartz clocks, GPS, etc.). In other words, it can be understood that the transmission delay corresponding to the core service SnapServer can be determined based on NTP, and based on this transmission delay, the first audio data can be synchronized with the target terminal. That is, optionally, in some embodiments, the step that “the first audio data is synchronized with the target terminal corresponding to the target software based on the core service and the Network Time Protocol” may specifically include:
(41) software that is in the same core serving network as the local software is determined as target software;
(42) a transmission delay is determined according to a Network Time Protocol; and
(43) the forwarded first audio data is synchronized with a target terminal corresponding to the target software by the core service based on the transmission delay.

After the target software establishes a communication connection with the local software, the target software can send an audio acquisition instruction to local software, when the local software receives the audio acquisition instruction and generates an audio transmission instruction, and when the target software sends the audio acquisition instruction to the local software, the local software sends a NTP request message to the NTP server including a time stamp t1 at which the NTP request message leaves the software, and the NTP request message arrives at the NTP server at time t2. After NTP server processing, a NTP response message is sent out at time t3. The NTP response message carries the time stamp t1, the time stamp t2, and the time stamp t3. When the response message is received, the local software records the time stamp t4 of the message return, and then calculates the transmission delay offset=[(t2−t1)+(t3-t4)]/2 based on the time stamps. The local software can adjust the current clock according to the transmission delay offset to achieve synchronization with the clock of the NTP server. It should be noted that, in this embodiment, the NTP server is the core service's corresponding server.

103, second audio data sent by the target software is received.

In this step, the second audio data is an integrated result of user audio data collected by the target software. Specifically, taking a scenario of a multi-person conference as an example, where the local software corresponds to the host and the target software corresponds to the participants: in a multi-person conference scenario, there are often multiple participants, meaning that one target software can correspond to multiple terminals, that is, multiple streams of sound data are transmitted to the target software. Specifically, the physical microphone corresponding to the target software collects sound signals from the external environment, and these external sound signals contain the voice signals of the users as well as ambient noise. Before the sound signals collected by the physical microphone are transmitted, noise reduction processing can be performed on these signals. Subsequently, the target terminal corresponding to the target software transmits the noise-reduced sound signals to an audio integration unit, which packages the transmitted sound signals to obtain the second audio data. That is, optionally, in some embodiments, the step that “the second audio data sent by the target software is received” may specifically include:
(51) the virtual microphone is controlled to collect user audio data of a physical microphone corresponding to target software; and
(52) multiple streams of user audio data are integrated to obtain second audio data.

It should be noted that during sound integration, a time synchronization mechanism needs to be employed to achieve time synchronization consistency among multiple terminals and the terminal where the target software is located. The time synchronization mechanism can utilize the NTP strategy mentioned earlier for synchronization, which will not be described further herein.

104, the second audio data is sent to a virtual microphone by a second virtual interface of the virtual microphone, and the second audio data in the virtual microphone is sent to the local software, so that the local software inputs the audio data.

It can be understood that since the virtual sound card operates in the kernel mode of the operating system, that is, the virtual microphone is also located in the kernel mode, while local software operates in the user mode of the operating system, to enable communication between the virtual loudspeaker and the local software, in some embodiments of this disclosure, a data interface (i.e., the second virtual interface) for communication between the virtual microphone and the local software is preset for data exchange. Specifically, the virtual loudspeaker serves as a preset virtual input device for the local software, and this virtual microphone is configured to control input audio data, such as adjusting volume levels, etc.

The virtual microphone does not directly interact with the second audio data. During actual transmission, the second audio data is buffered into a second preset buffering area via the second virtual interface, and the virtual microphone then extracts the second audio data from this second preset buffering area, thereby enabling the transmission of the second audio data from the virtual microphone to the local software. That is, optionally, in some embodiments, the step that “the second audio data is sent to the virtual microphone by the second virtual interface of the virtual microphone, and the second audio data in the virtual microphone is sent to the local terminal corresponding to the local software” may specifically include:
(61) the second audio data is buffered into a second preset buffering area by a second virtual interface of a virtual microphone based on a microphone forwarding service; and
(62) the virtual microphone is controlled to extract the buffered second audio data from the second preset buffering area, and the extracted second audio data is sent to a local terminal corresponding to the local software.

Wherein, this microphone forwarding service is bound to the second preset buffering area. The microphone forwarding service is configured to buffer the second audio data from the sound integration unit into the second preset buffering area by the second virtual interface. When the virtual microphone operates as an independent thread, it controls the extraction of the buffered second audio data from the second preset buffering area and sends the extracted second audio data to the local terminal corresponding to the local software.

Optionally, in some embodiments, the step that “the second audio data is buffered into the second preset buffering area by the second virtual interface of the virtual microphone based on the microphone forwarding service” may specifically include: the second audio data is buffered into a second preset buffering area by a second virtual interface of a virtual microphone in response to a data transmission instruction of the speaker forwarding service for the second preset buffering area.

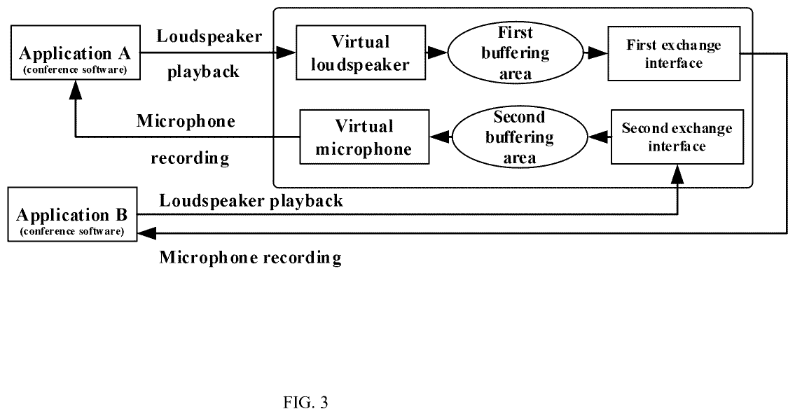

To further understand the audio processing solution of this disclosure, the virtual sound card provided in this disclosure will be further elaborated upon below. This disclosure provides a virtual sound card through which Application A can exchange audio data with Application B. As illustrated in FIG. 3, the virtual sound card includes a virtual loudspeaker, a first buffering area, a first exchange interface, a virtual microphone, a second buffering area, and a second exchange interface. Application A plays sound through the virtual loudspeaker of the virtual sound card, and the sound passes through the first buffering area, then the audio data is transmitted to Application B via the first exchange interface, achieving a “microphone recording” effect. Similarly, Application B sends audio data to the second exchange interface of the virtual sound card in a “speaker playback” manner. The second exchange interface stores the audio data in the second buffering area and then forwards it to the virtual microphone, ultimately enabling Application A to implement the recording function of the virtual microphone.

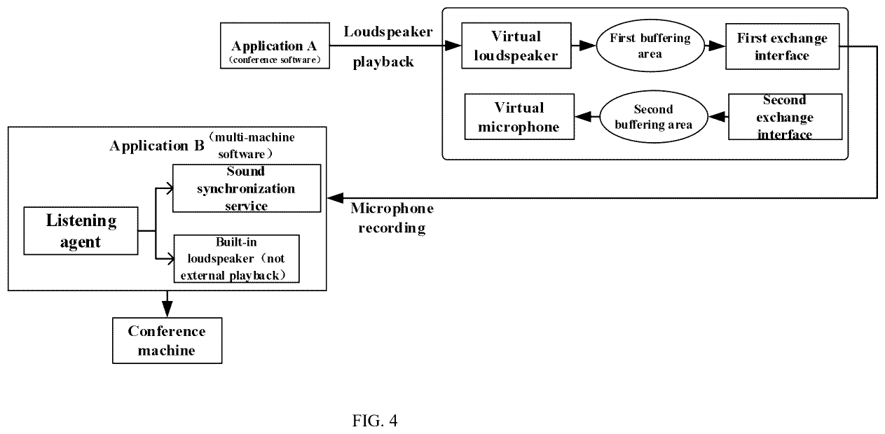

Further, referring to FIG. 4, third-party applications can access the virtual loudspeaker through the sound card driver, with their sound routed through the listening agent of the multi-machine software, supporting audio monitoring/log monitoring/control. The multi-machine software extracts corresponding audio data from the first buffering area through the first exchange interface via the multi-machine sound synchronization service. Subsequently, the audio data is synchronously sent to multiple conference machines. Additionally, the monitoring function through other built-in speakers is also supported.

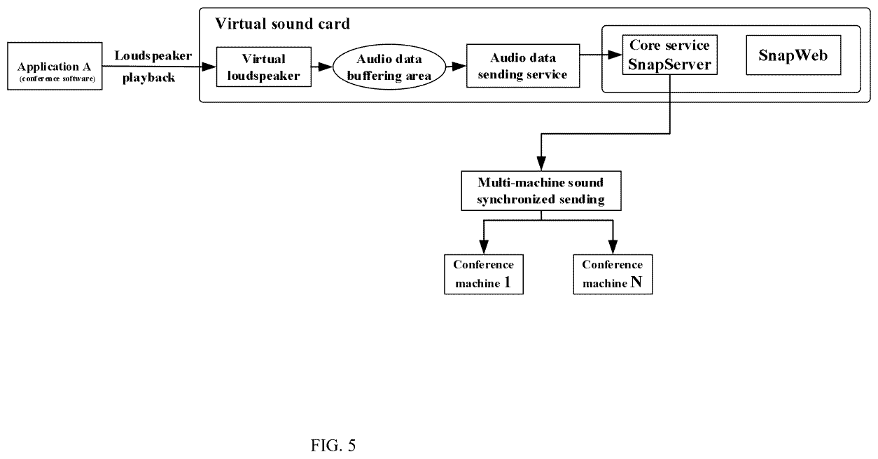

Optionally, this disclosure provides a virtual loudspeaker with audio data buffering, as shown in FIG. 5. An application obtains the virtual loudspeaker by accessing a system driver, and then uses a Windows sound card interface to play audio through the virtual loudspeaker. After the virtual loudspeaker receives sound, the virtual sound card buffers the sound into an audio data buffering area. The size of this buffering area is configurable, and it is generally recommended not to exceed a buffer size of 100 ms. The audio data transmission service forwards the buffered audio data to a multi-stage audio synchronization transmission service. Based on the NTP synchronization mechanism, the audio data is synchronously sent to multiple audio terminals [the speakers of conference machines], enabling the sound of the application to be synchronously played out on each conference machine.

Furthermore, the virtual loudspeaker is controlled by multi-machine software. The sound from the conference software is distributed and played through the virtual loudspeaker. The virtual loudspeaker forwards the audio data to the core service SnapServer, which then synchronizes the audio data with the multi-machine software. SnapServer supports multiple client connections, enabling synchronized audio playback across Conference Machine 1 to Conference Machine N.

Since the default audio interface of the virtual loudspeaker and the core service SnapServer cannot directly send and receive audio data, a customized audio data forwarding service for the speaker is required. This service provides a data buffer queue and audio forwarding capability. When the conference software sends audio to the virtual loudspeaker, the virtual loudspeaker does not directly play the audio but instead pushes the audio data into the data buffer queue. The audio forwarding service, operating as an independent thread, continuously acquires audio data from the data buffer queue and sends it to the core service SnapServer. Ultimately, SnapServer uniformly forwards the audio data to each SnapClient for playback.

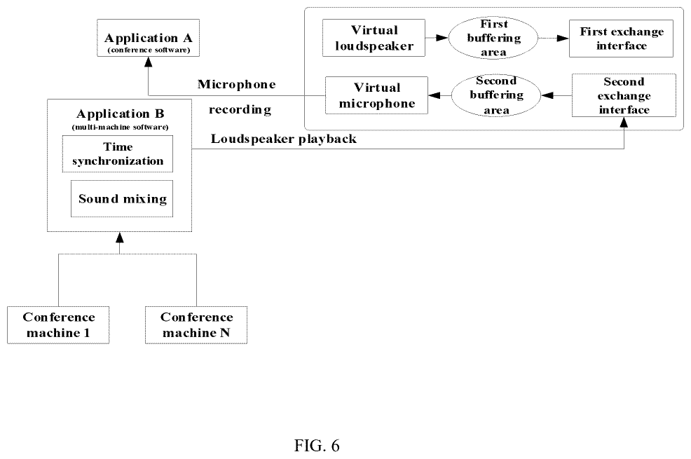

Optionally, referring to FIG. 6, FIG. 6 is yet another schematic diagram of data exchange in a unified virtual sound card according to an embodiment of the present disclosure. Through the sound mixing mechanism of the multi-machine software, a multi-channel conference machine synchronously integrates multiple audio streams and then converts them into a single upstream stream to be pushed to the virtual microphone. This virtual microphone then supplies the audio to third-party applications, such as conference software and audio-video recording software, for audio collection. During sound mixing, the time synchronization mechanism is required to achieve time synchronization consistency between the multi-channel conference machine and the host where the multi-machine software resides.

Since the default audio interface of the virtual microphone and a sound mixing output unit of the multi-machine software cannot directly send and receive audio data, it is necessary to provide a customized microphone audio data forwarding service that offers a data buffer queue and audio forwarding capability. When the multi-machine software sends audio to the virtual microphone, the virtual microphone does not directly receive the audio. Instead, the sound mixing output unit needs to send the audio data to the microphone audio data forwarding service, which then pushes the received audio data into the data buffer queue. The virtual microphone, operating as an independent thread, periodically acquires audio data from the microphone data buffer queue and sends it to the conference computer software. Ultimately, the conference computer software uniformly forwards the audio data to various remote conference terminals.

It can be understood that the speaker and microphone of a multi-machine virtual sound card feature a one-to-many characteristic. Specifically, the speaker of a multi-machine microphone actually outputs to multiple conference machines for synchronized playback. The implementation involves broadcasting sound from the virtual loudspeaker to multiple conference machines, with the playback controlled through NTP time synchronization, combined with automatic adjustment of the playback speed.

The sound of the microphone of the multi-machine virtual sound card is collected from the microphone heads of multiple conference machines. These conference machines perform sound collection, background noise elimination, and automatic volume adjustment. After that, the multiple audio streams are synchronously mixed and combined into a single audio stream, which is then provided to the virtual microphone.

The audio processing method based on multi-machine interaction provided by the embodiment includes: in response to an audio transmission instruction triggered by local software, acquiring first audio data corresponding to the audio transmission instruction; synchronizing the first audio data with target software by a first virtual interface of a virtual loudspeaker, so that the local software outputs the audio data; receiving second audio data sent by the target software; and sending the second audio data to a virtual microphone by a second virtual interface of the virtual microphone, and sending the second audio data in the virtual microphone to the local software, so that the local software inputs the audio data. In the audio processing solution provided by this disclosure, the local software can output the first audio data to the target software through the first virtual interface of a virtual loudspeaker. Meanwhile, the target software can input the second audio data into the local software through the second virtual interface of a virtual microphone. In other words, audio data input and output for the target software are achieved through a single virtual sound card. It can be seen that, in a multi-machine interaction scenario, there is no need to configure multiple virtual sound cards, thus avoiding adjustment errors caused by different names of virtual sound cards.

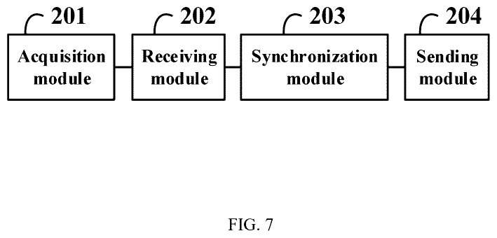

Accordingly, referring to FIG. 7, an embodiment of the present disclosure provides an audio processing apparatus based on multi-machine interaction (hereinafter referred to as a processing apparatus), including:
an acquisition module 201, configured to, in response to an audio transmission instruction triggered by local software, acquire first audio data corresponding to the audio transmission instruction;
a synchronization module 202, configured to synchronize the first audio data with target software by a first virtual interface of a virtual loudspeaker, so that the local software outputs the audio data, the virtual loudspeaker being a preset virtual output device of the local software; wherein the virtual loudspeaker is configured to control output audio data;
a receiving module 203, configured to receive second audio data sent by the target software, the second audio data being an integration result of user audio data collected by the target software; and
a sending module 204, configured to send the second audio data to a virtual microphone by a second virtual interface of the virtual microphone, and sending the second audio data in the virtual microphone to the local software, so that the local software inputs the audio data, the virtual microphone being a preset virtual input device of the local software; wherein the virtual microphone is configured to control input audio data.

Optionally, in some embodiments, the synchronization module 202 specifically may include:
a buffering unit, configured to buffer the first audio data into a first preset buffering area by a virtual loudspeaker; and
a synchronization unit, configured to synchronize the first audio data buffered in the first preset buffering area with a terminal corresponding to target software by a first virtual interface of the virtual loudspeaker based on a speaker forwarding service.

Optionally, in some embodiments, the synchronization unit specifically may include:
a buffering subunit, configured to forward first audio data buffered in the first preset buffering area to a core service by a first virtual interface of the virtual loudspeaker in response to an extraction instruction of a speaker forwarding service for the first preset buffering area; and
a synchronization subunit, configured to synchronize the first audio data with a target terminal corresponding to target software based on the core service and a network time protocol.

Optionally, in some embodiments, the synchronization subunit specifically may be configured to: determine software that is in the same core serving network as the local software as target software; determine a transmission delay according to a network time protocol; and synchronize the forwarded first audio data with a target terminal corresponding to the target software by the core service based on the transmission delay.

Optionally, in some embodiments, the receiving module 203 specifically may be further configured to: control the virtual microphone to collect user audio data of a physical microphone corresponding to target software; and integrate multiple streams of user audio data to obtain second audio data.

Optionally, in some embodiments, the sending module 204 specifically may be configured to: buffer the second audio data into a second preset buffering area by a second virtual interface of a virtual microphone based on a microphone forwarding service; and control the virtual microphone to extract the buffered second audio data from the second preset buffering area, and send the extracted second audio data to a local terminal corresponding to the local software.

Optionally, in some embodiments, the sending module 204 specifically may be configured to: buffer the second audio data into a second preset buffering area by a second virtual interface of a virtual microphone in response to a data transmission instruction of the speaker forwarding service for the second preset buffering area.

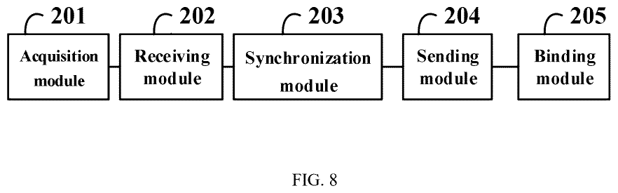

Optionally, in some embodiments, please refer to FIG. 8, the process of the present disclosure specifically may further include a binding module 205, which specifically may be configured to: preset a virtual sound card including one virtual loudspeaker and one virtual microphone; and bind the virtual sound card with local software so that the local software performs data input and output by the virtual sound card.

From the above, in the audio processing apparatus based on multi-machine interaction of this embodiment, the acquisition module 201, in response to an audio transmission instruction triggered by local software, acquires first audio data corresponding to the audio transmission instruction; the synchronization module 202 synchronizes the first audio data with target software by a first virtual interface of a virtual loudspeaker, so that the local software outputs the audio data; the receiving module 203 receives second audio data sent by the target software; and the sending module 204 sends the second audio data to a virtual microphone by a second virtual interface of the virtual microphone, and sends the second audio data in the virtual microphone to the local software, so that the local software inputs the audio data. In the audio processing solution provided by this disclosure, the local software can output the first audio data to the target software through the first virtual interface of a virtual loudspeaker. Meanwhile, the target software can input the second audio data into the local software through the second virtual interface of a virtual microphone. In other words, audio data input and output for the target software are achieved through a single virtual sound card. It can be seen that, in a multi-machine interaction scenario, there is no need to configure multiple virtual sound cards, thus avoiding adjustment errors caused by different names of virtual sound cards.

Embodiments of the disclosure also provide a computer device including a processor and a memory having stored therein a computer program which, when loaded and executed by the controller, implements the method steps of any one of the above method embodiments.

Embodiments of the present disclosure also provide a computer storage medium having stored therein a computer program which, when executed, implements the method steps of any one of the above method embodiments.

In the above-described embodiments provided herein, it should be understood that the disclosed system, apparatus, and method may be implemented in other ways. For example, the division of units is solely for the purpose of logical functional division, and in actual implementation, there may be alternative ways of division. For example, multiple units or components can be combined or integrated into another system, or certain features may be omitted or not executed. Additionally, the couplings or direct couplings or communication connections shown or discussed between various components can be indirect couplings or communication connections via some interfaces, apparatuses, or units, which may take electrical, mechanical, or other forms.

The units described as separate components may or may not be physically separated, and the components shown as units may or may not be physical units. That is, they can be located in one place or distributed across multiple network units. Depending on actual needs, some or all of these units can be selected to achieve the objective of the solution in this embodiment.

In addition, the functional units in each embodiment of this application can be integrated into a single processing unit, or they can exist as separate physical units. Alternatively, two or more units can be integrated into a single unit. These integrated units can be implemented in the form of hardware or as software functional units. When the integrated units are implemented in the form of software functional units and sold or used as independent products, they can be stored in a computer-readable storage medium.

Based on such understanding, the essence of the technical solution in this application, or the part that makes contributions, or all or part of the technical solution, can be embodied in the form of a software product. This computer software product is stored in a storage medium and includes several instructions that enable a computer device (which can be a mobile terminal, personal computer, server, network equipment, etc.) to execute all or part of the steps described in various embodiments of this application. The aforementioned storage medium includes a USB disk, a removable hard disk, a read-only memory (ROM), a Random Access Memory (RAM), a magnetic disk, an optical disk, and various media capable of storing program codes.

In summary, although the present disclosure has been disclosed in terms of preferred embodiments as described above, the scope of protection of the present disclosure is not limited thereto, and those skilled in the art who makes equivalent substitutions or changes according to the concepts of the technical solutions of the present disclosure within the technical scope disclosed in the present disclosure should be covered by the scope of protection of the present disclosure.

The technical features of the above-described embodiments can be arbitrarily combined, and all possible combinations of the technical features of the above-described embodiments have not been described in order to make the description concise, but as long as there is no contradiction between the combinations of these technical features, they should be considered to be within the scope of the present specification.

What is claimed is:

1. An audio processing method based on multi-machine interaction, comprising:
in response to an audio transmission instruction triggered by local software, acquiring first audio data corresponding to the audio transmission instruction;
buffering the first audio data into a first preset buffering area by a virtual loudspeaker;
synchronizing the first audio data buffered in the first preset buffering area with a terminal corresponding to target software by a first virtual interface of the virtual loudspeaker based on a speaker forwarding service, the virtual loudspeaker being a pre-set virtual output device of the local software; wherein the virtual loudspeaker is configured to control output audio data;
receiving second audio data sent by the target software, the second audio data being an integration result of user audio data collected by the target software;
buffering the second audio data into a second preset buffering area by a second virtual interface of a virtual microphone based on a microphone forwarding service; and
controlling the virtual microphone to extract the buffered second audio data from the second preset buffering area, and send the extracted second audio data to a local terminal corresponding to the local software, the virtual microphone being a pre-set virtual input device of the local software; wherein the virtual microphone is configured to control input audio data.

2. An audio processing method based on multi-machine interaction, comprising:
in response to an audio transmission instruction triggered by local software, acquiring first audio data corresponding to the audio transmission instruction;
synchronizing the first audio data with target software by a first virtual interface of a virtual loudspeaker, so that the local software outputs the audio data, the virtual loudspeaker being a preset virtual output device of the local software; wherein the virtual loudspeaker is configured to control output audio data;
receiving second audio data sent by the target software, the second audio data being an integration result of user audio data collected by the target software; and
sending the second audio data to a virtual microphone by a second virtual interface of the virtual microphone, and sending the second audio data in the virtual microphone to the local software, so that the local software inputs the audio data, the virtual microphone being a preset virtual input device of the local software; wherein the virtual microphone is configured to control input audio data.

3. The audio processing method according to claim 2, wherein synchronizing the first audio data with the target software by the first virtual interface of the virtual loudspeaker comprises:
buffering the first audio data into a first preset buffering area by the virtual loudspeaker; and
synchronizing the first audio data buffered in the first preset buffering area with a terminal corresponding to target software by a first virtual interface of the virtual loudspeaker based on a speaker forwarding service.

4. The audio processing method according to claim 3, wherein synchronizing the first audio data buffered in the first preset buffering area with the terminal corresponding to the target software by the first virtual interface of the virtual loudspeaker based on the speaker forwarding service comprises:
forwarding first audio data buffered in the first preset buffering area to a core service by a first virtual interface of the virtual loudspeaker in response to an extraction instruction of a speaker forwarding service for the first preset buffering area; and
synchronizing the first audio data with a target terminal corresponding to target software based on the core service and a Network Time Protocol.

5. The audio processing method according to claim 4, wherein synchronizing the first audio data with the target terminal corresponding to the target software based on the core service and the Network Time Protocol comprises:
determining software that is in the same core serving network as the local software as target software;
determining a transmission delay according to a Network Time Protocol; and
synchronizing the forwarded first audio data with a target terminal corresponding to the target software by the core service based on the transmission delay.

6. The audio processing method according to claim 2, wherein sending the second audio data to the virtual microphone by the second virtual interface of the virtual microphone, and sending the second audio data in the virtual microphone to the local terminal corresponding to the local software comprises:
buffering the second audio data into a second preset buffering area by a second virtual interface of a virtual microphone based on a microphone forwarding service; and
controlling the virtual microphone to extract the buffered second audio data from the second preset buffering area, and send the extracted second audio data to a local terminal corresponding to the local software.

7. The audio processing method according to claim 6, wherein buffering the second audio data into the second preset buffering area by the second virtual interface of the virtual microphone based on the microphone forwarding service comprises:
buffering the second audio data into a second preset buffering area by a second virtual interface of a virtual microphone in response to a data transmission instruction of the speaker forwarding service for the second preset buffering area.

8. The audio processing method according to claim 2, wherein prior to receiving the second audio data sent by the target software, the method comprises:
controlling the virtual microphone to collect user audio data of a physical microphone corresponding to target software; and
integrating multiple streams of user audio data to obtain second audio data.

9. The audio processing method according to claim 2, further comprising:
presetting a virtual sound card comprising one virtual loudspeaker and one virtual microphone; and
binding the virtual sound card with local software so that the local software performs data input and output by the virtual sound card.

10. An audio processing apparatus based on multi-machine interaction, comprising:
an acquisition module, configured to, in response to an audio transmission instruction triggered by local software, acquire first audio data corresponding to the audio transmission instruction;
a synchronization module, configured to synchronize the first audio data with target software by a first virtual interface of a virtual loudspeaker, so that the local software outputs the audio data, the virtual loudspeaker being a preset virtual output device of the local software; wherein the virtual loudspeaker is configured to control output audio data;
a receiving module, configured to receive second audio data sent by the target software, the second audio data being an integration result of user audio data collected by the target software; and
a sending module, configured to send the second audio data to a virtual microphone by a second virtual interface of the virtual microphone, and sending the second audio data in the virtual microphone to the local software, so that the local software inputs the audio data, the virtual microphone being a preset virtual input device of the local software;
wherein the virtual microphone is configured to control input audio data.

11. A non-transitory storage medium having stored thereon a computer program, wherein the computer program implements the steps of the audio processing method based on multi-machine interaction according to claim 1 when executed by a processor.
